(19) United States
(12) Patent Application Publication
(10) Pub. No.: US 2019/0034844 A1
(43) Pub. Date: Jan. 31, 2019

(54) UPDATING ENTERPRISE RESOURCE SYSTEMS

(71) Applicant: Remini Street, Inc., Las Vegas, NV (US)

(72) Inventors: GREG R. PROW, SARATOGA, CA (US); MIKKEL WILLIAM LANTZ, SANTA CLARA, CA (US); DOUGLAS WILLIAM BARON, CENTREVILLE, VA (US)

(21) Appl. No.: 16/146,341

(22) Filed: Sep. 28, 2018

Related U.S. Application Data
(63) Continuation-in-part of application No. 12/907,436, filed on Oct. 19, 2010, now abandoned.
(60) Provisional application No. 61/388,961, filed on Oct. 1, 2010.

(51) Int. Cl. G06Q 10/06; G06F 17/30

(52) U.S. Cl. CPC G06Q 10/0631; G06F 17/30997; G06F 17/30876; G06F 17/30002

(57) ABSTRACT

An electronic reference at a content host can be accessed to identify a modification to metadata impacting the functioning of an enterprise resource system. A change memo host can generate a change memo with a first entry incorporating a digital reproduction of the electronic reference capturing the metadata, where the generated change memo can be confirmed based on a second entry for an additional electronic reference also identifying the modification to the metadata impacting the functioning of the enterprise resource system. In response to tracking a status of the change memo by the change memo host, an update of the enterprise resource system can be prompted based on the metadata associated with the electronic reference, where the tracked status indicating that the modification of the metadata is confirmed.

### CROSS-REFERENCE TO RELATED APPLICATIONS

This application is a continuation-in-part of U.S. Ser. No. 12/907,436, entitled “CAPTURING AND REVIEWING CHANGES IMPACTING ENTERPRISE RESOURCE PLANNING SYSTEMS,” filed on Oct. 19, 2010, which claims the benefit of U.S. Provisional Application No. 61/388,961, entitled “CAPTURING AND REVIEWING CHANGES IMPACTING ENTERPRISE RESOURCE PLANNING SYSTEMS,” filed Oct. 1, 2010, both of which are herein incorporated by reference in their entireties.

### BACKGROUND

An enterprise resource planning (ERP) system is an information management system that facilitates management of resources within an organization. A number of ERP systems are commercially available. Among other things, an ERP system may integrate an organization's various business functions, such as human resources, finance, marketing, and sales.

ERP systems typically provide calculations, reporting, and other functions that are based on legal requirements (e.g., statutes, regulations, etc.) and other guidelines. Often, governments, municipalities, and other authorities make changes that affect these functions provided by ERP systems. For instance, a state may change its sales tax, which would affect a sales function of an ERP system that tracks an organization's sales including data regarding sales tax.

When a government, municipality, or other entity makes a change that impacts an ERP system, an update to the ERP system is needed to allow the ERP system to accurately perform the function affected by the change. Identifying such changes and updating the ERP system presents an imposing challenge. In particular, a change that impacts the ERP system must first be discovered. After discovering a change, a development team must implement a software update to the ERP system. Given the breadth of functions provided by ERP systems, a large number of legal requirements and other guidelines may impact ERP systems. Periodically reviewing such a large source of information to identify changes is a daunting and labor-intensive task. Additionally, tracking the various changes to coordinate updates to the ERP system presents a challenge. In some instances, changes may not be validated and updates may be made that are not warranted. For instance, an information source may incorrectly identify a change that has not actually been implemented or may have particulars of a change incorrect. As a result, some ERP system functions may be outdated or may include inaccuracies.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to a change memo system that facilitates the identification and review of changes to legal requirements and/or other guidelines that may impact ERP systems. The change memo system tracks electronic references related to legal requirements and/or other guidelines for changes. When a change is detected, a change memo may be created as a record of the change. The system facilitates review of the change memo, including tracking a review status of the change memo. The review may include, among other things, determining whether the change warrants an update to an ERP system and validating the change. Once a change memo is approved, information from the change memo may be employed for developing and implementing an update to an ERP system.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a flow diagram showing an overall method for identifying and reviewing changes that may impact ERP systems in accordance with an embodiment of the present invention;

FIG. 4 is a flow diagram showing a method for automatically identifying reference changes that may impact ERP systems in accordance with an embodiment of the present invention;

FIG. 5 is a flow diagram showing a change review process in accordance with an embodiment of the present invention;

FIG. 6 is a flow diagram showing a method for initially reviewing changes made to references in accordance with an embodiment of the present invention;

FIG. 7 is a flow diagram showing a method for determining the relevance of a change made to a reference in accordance with an embodiment of the present invention;

FIG. 8 is a flow diagram showing a method for reviewing future changes in accordance with an embodiment of the present invention;

FIG. 9 is a flow diagram showing a method for reviewing critical updates in accordance with an embodiment of the present invention;

FIGS. 10A and 10B provide a flow diagram showing a method for validating a change and publishing the change for development in accordance with an embodiment of the present invention;

FIG. 11 is a flow diagram showing a method for reviewing a reference change and tracking the status of a corresponding change memo during the review process in accordance with an embodiment of the present invention;

FIG. 12 is an illustrative screen display of a user interface for managing references tracked by a change memo system in accordance with an embodiment of the present invention;

FIG. 13 is an illustrative screen display of a user interface for viewing details of a reference record in accordance with an embodiment of the present invention;

FIG. 14 is an illustrative screen display of a user interface for editing details of a reference record in accordance with an embodiment of the present invention;

FIG. 15 is an illustrative screen display of a user interface for viewing reference captures in accordance with an embodiment of the present invention;

FIG. 16 is an illustrative screen display of a user interface for viewing details of a reference capture in accordance with an embodiment of the present invention;

FIG. 17 is an illustrative screen display of a user interface for managing change memos in accordance with an embodiment of the present invention;

FIG. 18 is an illustrative screen display of a user interface for viewing details of a change memo in accordance with an embodiment of the present invention;

FIGS. 19A and 19B provide an illustrative screen display of a user interface for editing details of a change memo in accordance with an embodiment of the present invention;

FIG. 20 is an illustrative screen display of a user interface for managing other references used to validate a change memo in accordance with an embodiment of the present invention; and

FIG. 21 is an illustrative screen display of a user interface for viewing the history of a change memo in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a change memo system that facilitates the identification and review of changes in legal requirements and/or other guidelines that may require updates to ERP systems. Initially, a number of electronic references are identified for tracking. The electronic references may each be directed to a legal requirement and/or other guideline that may be impact a function of an ERP system. The change memo system captures each reference on a periodic basis. For instance, in some cases, the electronic reference may be a web page, and the change memo system may be operable to access the web page to obtain content on a configurable basis. In other instances, the electronic reference may be a data feed (e.g., a news feed) that is periodically provided to the change memo system.

The change memo system operates to identify changes in each electronic reference by comparing a current version of the reference with a previous version. When a change is detected in a reference, the change memo system facilitates review of the change to determine whether an update to an ERP system is warranted based on the identified change. In particular, a change memo may be created and tracked by the change memo system to facilitate the review of an identified change. As used herein, the term “change memo” refers to a record that stores information regarding a change identified in an electronic reference. The change memo allows information regarding an identified change, including review of the change, to be documented and easily tracked. The change memo system stores the change memos in a change memo repository and provides user interfaces that allow users to view and edit details of the change memos.

In embodiments, the change memo system supports workflow processing to facilitate user review of change memos to determine whether to implement updates to ERP systems based on identified changes. In particular, the system facilitates review of each change memo to determine, among other things, whether the change associated with the change memo is one that warrants an update to an ERP system. Additionally, the system facilitates validation of the corresponding change by allowing entry of information identifying references that confirm the change. Ultimately, the system allows for the approval of a change memo such that a development team may develop and implement an update to an ERP system based on the change associated with the change memo.

During the review of a change memo, the system may track a current status of the change memo. The status reflects where the change stands in the review, validation, and approval process. In some embodiments, the change memo system may provide notifications to users regarding the status of each change memo and may prompt certain actions to be performed based on each change memo's current status.

Accordingly, in one aspect, an embodiment of the present invention is directed to one or more computer storage media storing computer-useable instructions that, when used by a computing device, cause the computing device to perform a method. The method includes periodically checking an electronic reference for changes, the electronic reference being directed to a legal requirement or other guideline that impacts a function of an ERP system. The method also includes identifying a change in the electronic reference. The method further includes creating a change memo based on the identified change, the change memo comprising a record that includes the identified change. The method still further includes tracking a review status of the change memo during a review process to determine whether to update the ERP system based on the identified change.

In another embodiment, an aspect of the invention is directed to a computerized system including at least one processor and at least one computer storage medium. The system includes a change identification component, a data store, and a user interface component. The change identification component tracks a plurality of electronic references for changes, each electronic reference being directed to a legal requirement or other guideline that impacts a function of an ERP system. The data store stores a plurality of change memos, each change memo comprising a record of information regarding a change identified in one of the plurality of electronic references. The user interface component provides user interfaces that facilitate review of the plurality of change memos to determine whether updates to the ERP system are warranted based on changes identified in the plurality of electronic references.

A further embodiment of the present invention is directed to one or more computer storage media storing computer-useable instructions that, when used by a computing device, cause the computing device to perform a method. The method includes receiving an indication of an electronic reference to track for changes, the electronic reference being directed to a legal requirement or other guideline that impacts a function of an ERP system. The method also includes capturing a first version of the electronic reference at a first time, capturing a second version of the electronic reference at a second time, and comparing the second version to the first version to determine if a change has been made to the electronic reference. The method further includes determining that a change has been made to the electronic reference and creating a change memo comprising a record that stores information regarding the change made to the electronic reference. The method also includes setting a change memo status to initial for the change memo and prompting a user to perform an initial review of the change memo. The method further includes receiving user input to set the change memo status to validate and prompting a user to perform a validation review of the change memo. The method still further includes receiving user input to set the change memo status to approve and providing a notification to one or more users of a development team that the change memo has been approved for developing and implementing an update to the ERP system based on the change to the electronic reference.

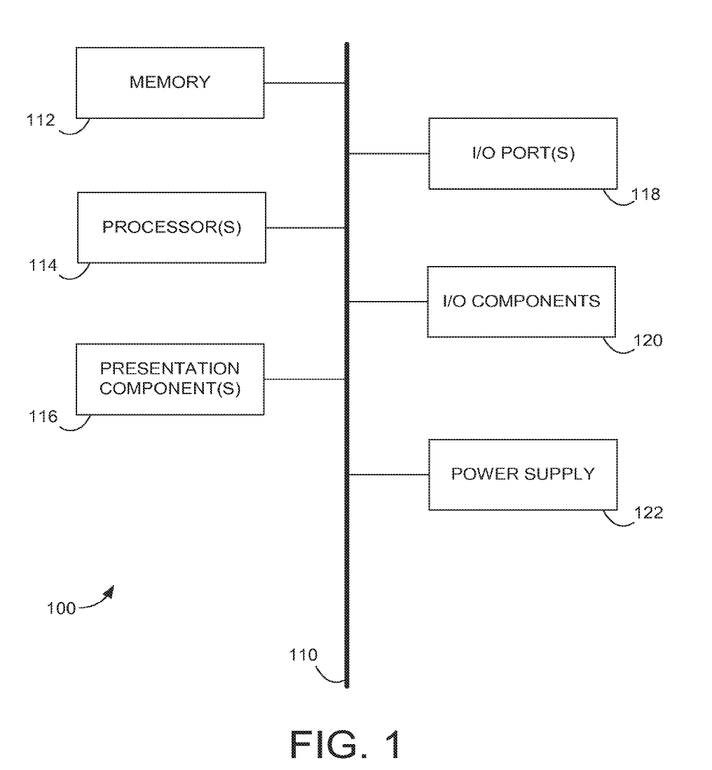

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

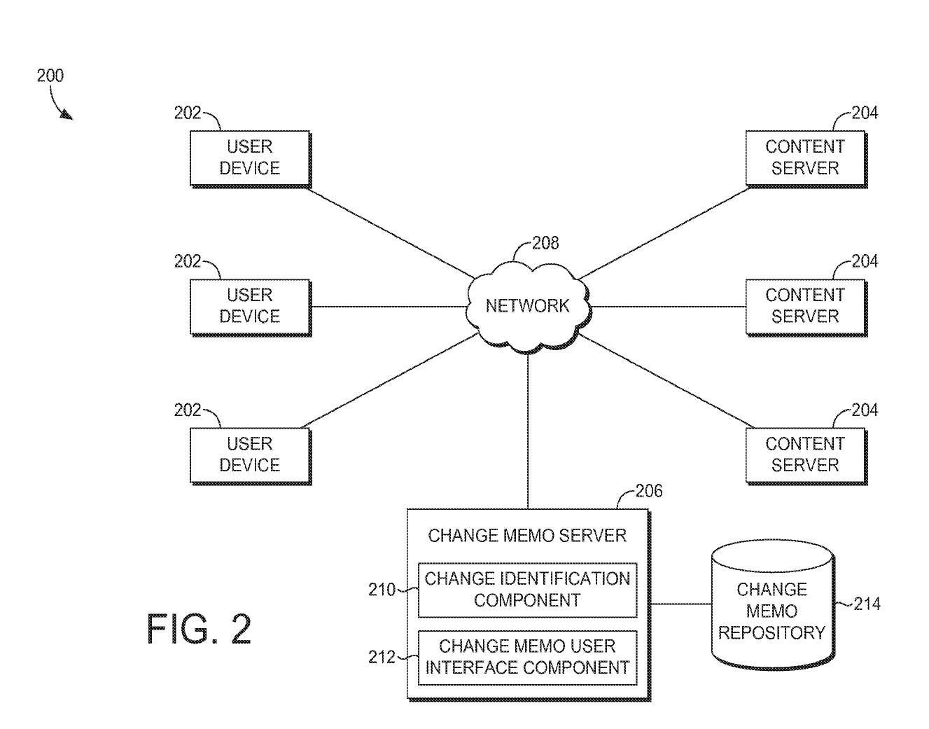

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a number of user devices 202, a number of content servers 204, and a change memo server 206. Each of the components shown in FIG. 2 may be any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, content servers, and change memo servers may be employed within the system 200 within the scope of the present invention. Each may comprise a single device or multiple devices cooperating in a distributed environment. For instance, the change memo server 206 may comprise multiple devices arranged in a distributed environment that collectively provide the functionality of the change memo server 206 described herein. Additionally, other components not shown may also be included within the system 200, while components shown in FIG. 2 may be omitted in some embodiments.

In accordance with embodiments of the present invention, the change memo server 206 operates to identify changes that may impact an ERP system and facilitates tracking the review of change memos that may result in updates to the ERP system. As shown in FIG. 2, the change memo server 206 includes, among other components not shown, a change identification component 210 and a change memo user interface component 212.

The change identification component 210 operates to identify changes that may impact and require updates to ERP systems. In accordance with embodiments of the present invention, a number of different references are identified for tracking changes. The references may be provided by government and/or third-party sources and be directed to legal requirements and/or other guidelines that may impact ERP systems. Generally, the references may include web pages, news feeds, and other electronic sources of information provided by content servers 204. As such, the change identification component 206 may track information that is pushed to and/or pulled by the change memo server 206. For instance, the change memo server 206 may include an automated component (not shown) that is employed to obtain content from identified web pages maintained by content servers 204. The component may obtain data on a configurable basis (e.g., daily, weekly, monthly, quarterly, etc.). In other instances, the change memo server 206 may receive news or other types of data feeds from content servers 204. In some embodiments, data may be manually entered into the change memo server 206 based on electronic documents, data feeds, etc.

The change identification component 210 operates by comparing different versions of electronic data to identify changes. For instance, the change identification component 210 may compare a current version of a web page directed to a particular regulation with a previous version to determine whether any changes to the web page have been made. As such, the change identification component 210 may determine whether a change to the particular regulation has occurred.

Any changes identified by the change identification component 210 may be stored in the change memo repository 214. In some embodiments, when a change is identified by the change identification component 210, a change memo can be automatically created and stored in the change memo repository 214. The change is indicated as a part of the created change memo. In other embodiments, a change memo is not automatically created when a change is identified by the change identification component 210. Instead, a record of the change is created and stored in the change memo repository 214. A reviewer may then access the change record and review the change to determine whether a change memo should be created for the change. Any and all such variations are contemplated to be within the scope of embodiments of the present invention.

Although only a single change memo repository 214 is shown in FIG. 2, it should be understood that multiple data stores may be provided in various embodiments of the present invention. For instance, one data store may be provided to store information regarding references being tracked and changes made to those references, while another data store may be provided to storing information regarding change memos.

The change memo server 206 also includes a change memo user interface component 212 that facilitates user interaction with the change memo server 206. In some embodiments, a user may employ a web browser on a user device 202 to interact with the change memo user interface component 212. In other embodiments, a client application may be installed on a user device 202 that is operable to communicate with the change memo user interface component 212.

The change memo user interface component 212 may provide user interfaces that allow users to interact with the system. Among other things, the user interfaces allow users to manage the references tracked by the change memo server 206. Additionally, the user interfaces allow users to access and manage change memos in the change memo repository 214. Accordingly, the user interfaces facilitate the review and validation of changes that may require updates to ERP systems. Users may view and edit information associated with each change memo, including a review status of the change memo. Based on the status of the change memo, the system may provide notifications to users and/or prompt users to perform particular review actions for the change memo. Once a change memo has been approved, the change memo server 206 may notify a development team, which may access information from the change memo and employ the information to generate and implement an update to an ERP system.

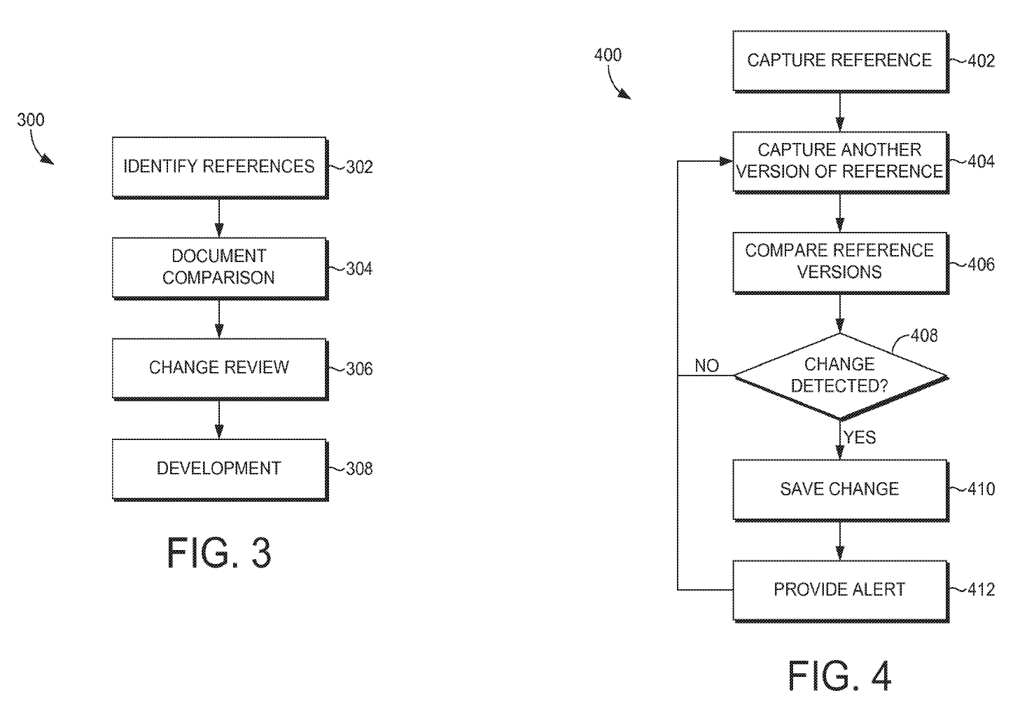

Turning next to FIG. 3, a flow diagram is provided that illustrates an overall method 300 for identifying and reviewing changes that may require an update to ERP systems in accordance with an embodiment of the present invention. Initially, as shown at block 302, references are identified for tracking. As noted above, the references may be provided by any government and/or third-party sources of information and are relevant to legal requirements and/or other guidelines that may impact ERP systems. Additionally, the references may include push and/or pull sources of information.

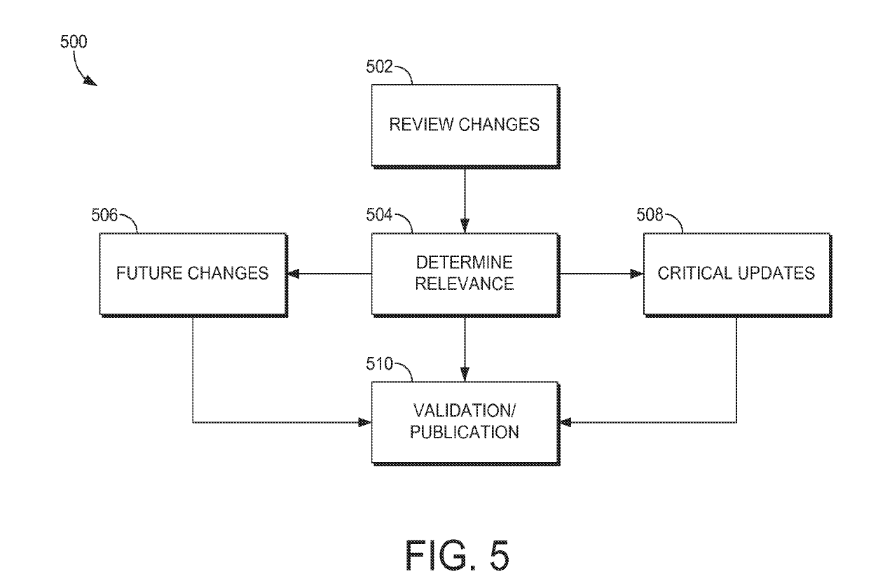

The process continues with document comparison to identify changes made within tracked references, as shown at block 304. An exemplary method 400 for comparing data to identify changes in references in accordance with one embodiment of the present invention is shown in FIG. 4. As shown at block 402 of FIG. 4, a reference is captured. For instance, the reference may be a web page, which is captured by obtaining a copy of the web page from a web server. As another example, the reference may be a web feed, which is captured when it is delivered to the change memo system or manually entered by personnel. Capturing a reference at block 402 may include capturing the entire reference or only a portion of the reference. As an example of a partial capture, the reference may include a combination of text and images, and only the text or a portion of the text may be captured. The system may be configurable to allow a user to control the portion of the reference to capture.

In embodiments, a reference is repeatedly captured according to a configurable schedule to determine if any changes have been made to the reference. For instance, a user may configure the system to capture a particular reference on a daily, weekly, monthly, quarterly, or other basis. Accordingly, when the period of time for recapture has been reached for the reference, a new version of the reference is captured, as shown at block 404. As at block 402, the entire reference or only a portion of the reference may be captured at block 404.

The reference versions are compared against one another to determine whether any changes have been made, as shown at block 406. In embodiments, the current version captured at block 404 is compared against the previous version captured at block 402 to determine whether the current version includes changes that may warrant an update to ERP systems. In accordance with various embodiments of the present invention, all or part of the captured portions of the reference may be compared at block 406. For instance, the whole reference may have been captured at blocks 402 and 404, but only a portion of the references may be compared at block 406.

A determination is made at block 408 regarding whether there are any changes between the previous and current versions of the reference. If no changes are detected, the process continues by capturing another version of the reference and performing another comparison according to the review schedule set for the reference. Alternatively, if a change is detected at block 408, information regarding the change between the current and previous versions of the reference is stored, as shown at block 410. In some embodiments, an indication that the reference has changed may be stored. In further embodiments, the changed portion may be stored with changes between the versions shown to facilitate further review.

An alert may also be provided to personnel responsible for reviewing the change, as shown at block 412. The alert may comprise an electronic notification, such as an email. In some embodiments, the change is added to a list of changes to be reviewed by personnel. In still further embodiments, a change memo may be automatically created based on the identified change or a change memo may be manually created after review of the change.

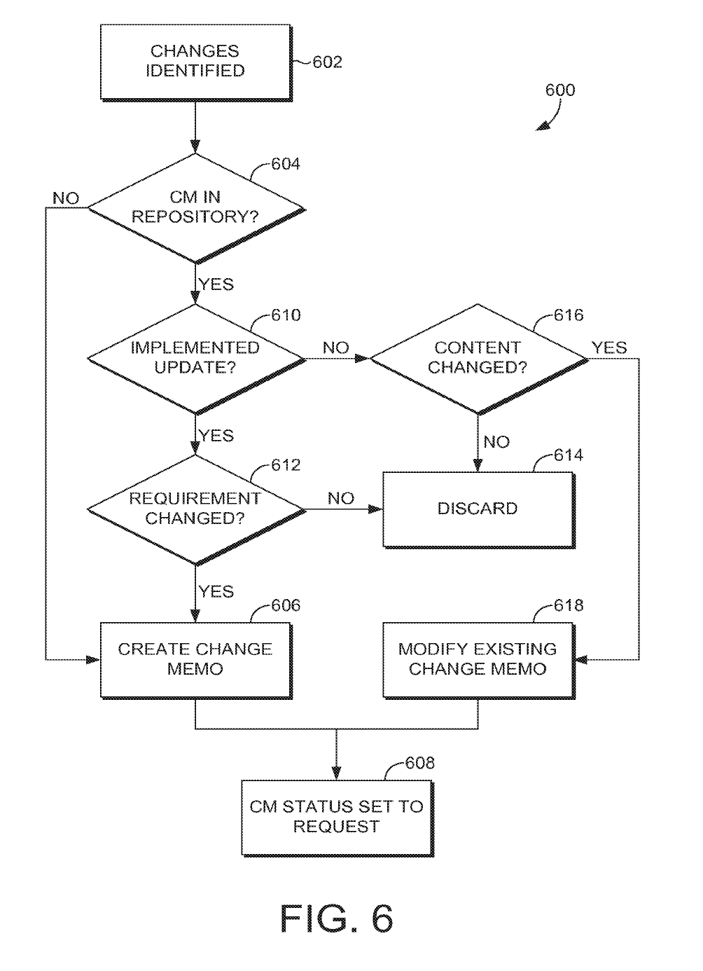

Returning to FIG. 3, after a change in a reference has been automatically identified by the system, a change review process is performed, as shown at block 306, which includes review of the identified change to determine whether an update to an ERP system is warranted based on the change. The review process may include creation of a change memo and a multi-stage review of the change memo before implementing an update to an ERP system. In accordance with embodiments of the present invention, user interfaces may be provided that allow personnel to view and edit details of each change memo, including managing a review status of the change memo during the review process. A change review process according to one embodiment of the present invention is discussed in further detail below with references to FIGS. 5 through 10.

If the review process indicates that a change to a reference warrants an update to an ERP system, a development process is performed, as shown at block 308. The development process includes developing and implementing an update to an ERP system based on the identified change.

Before implementing an update to the ERP system, the development process may include an ERP system test. The ERP system test may comprise executing the updated version of the ERP system in a testing environment prior to implementation. The testing environment may replicate one or more scenarios that the updated ERP system is likely to encounter after being implemented. The ERP system test can be utilized to determine if the updated ERP system accurately reflects or accounts for the change that was identified in the change memo. For example, the updated ERP system may be tested based on one or more testing parameters that would identify whether or not the updated ERP system produces accurate results based on the identified change. If the ERP system test is successful, the update to the ERP system that includes the change identified in the change memo may be approved for implementation. If the ERP system test is unsuccessful, then additional ERP system tests may be ran prior to implementation of the update.

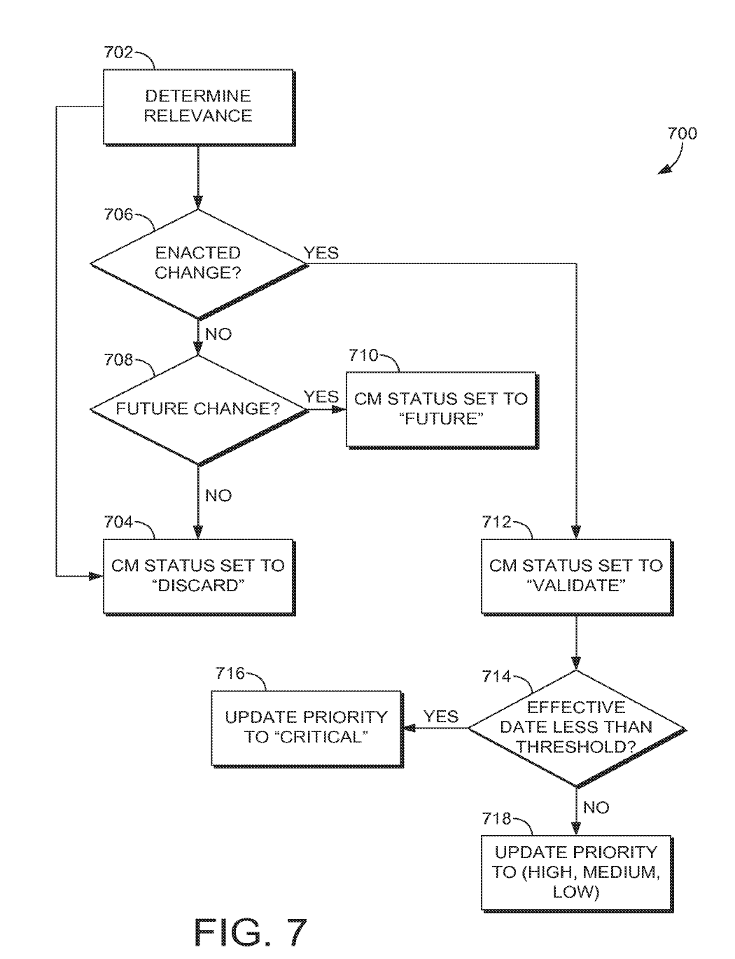

Referring now to FIG. 5, a change memo review process in accordance with one embodiment of the present invention is shown. In particular, a flow diagram is provided that illustrates a method 500 for reviewing a change to a reference to determine whether an update to an ERP system should be made based on the identified change. Each of the blocks shown in FIG. 5 will be further discussed with reference to FIGS. 6-10. It should be understood that the description of the review process provided with reference to FIGS. 5-10 is provided by way of example only and other change review processes may be employed within the scope of embodiments of the present invention.

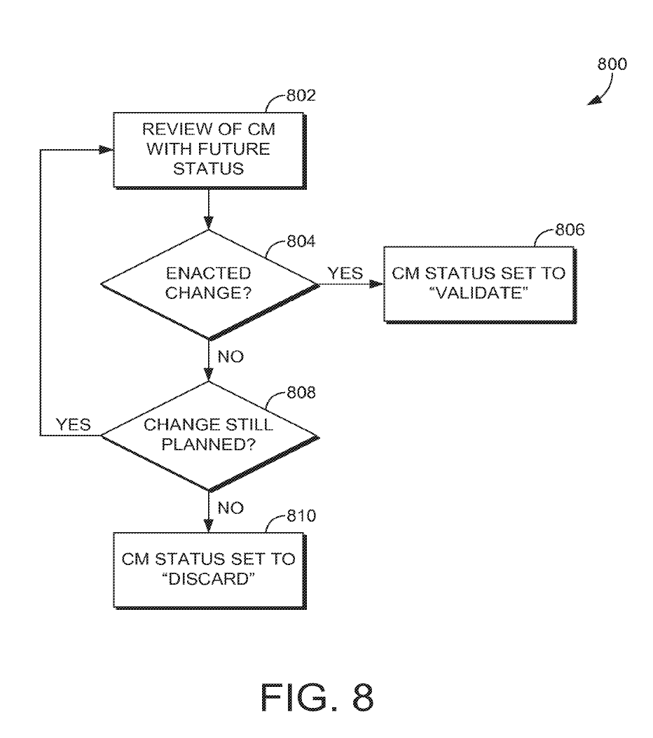

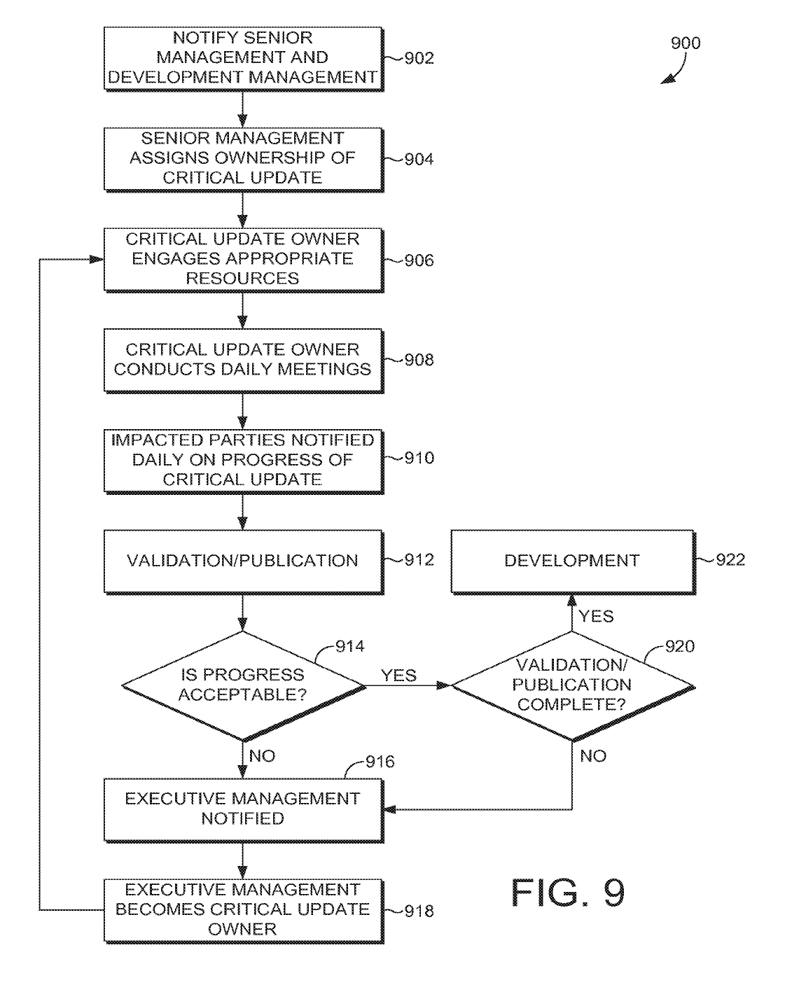

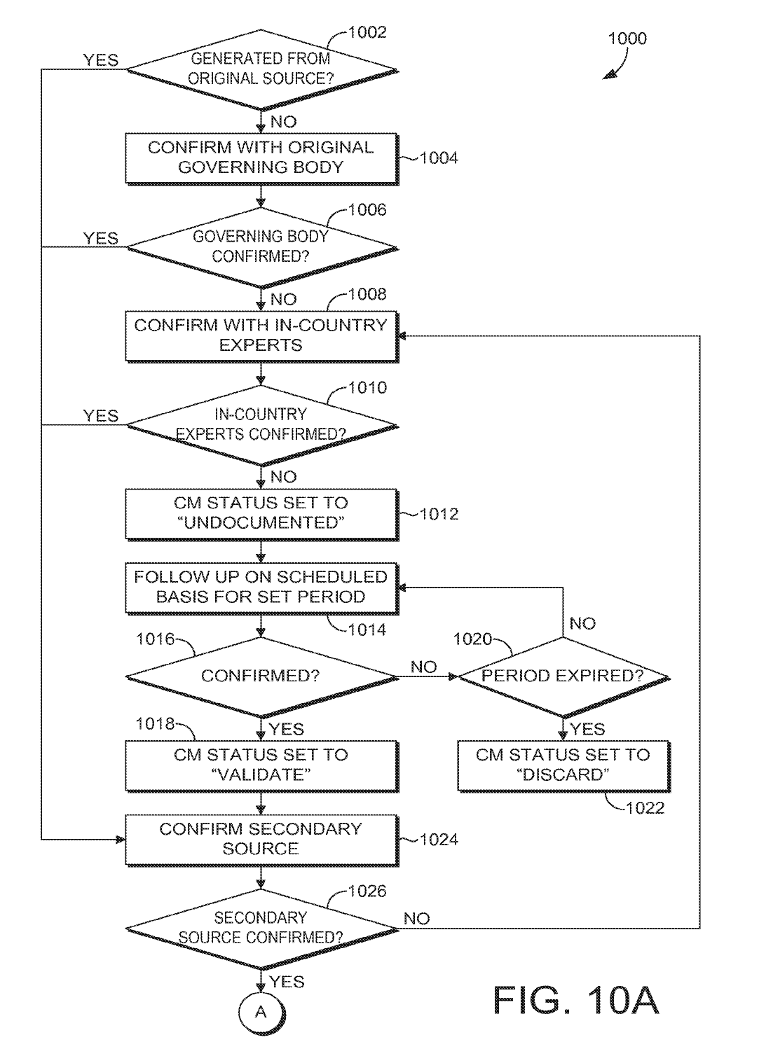

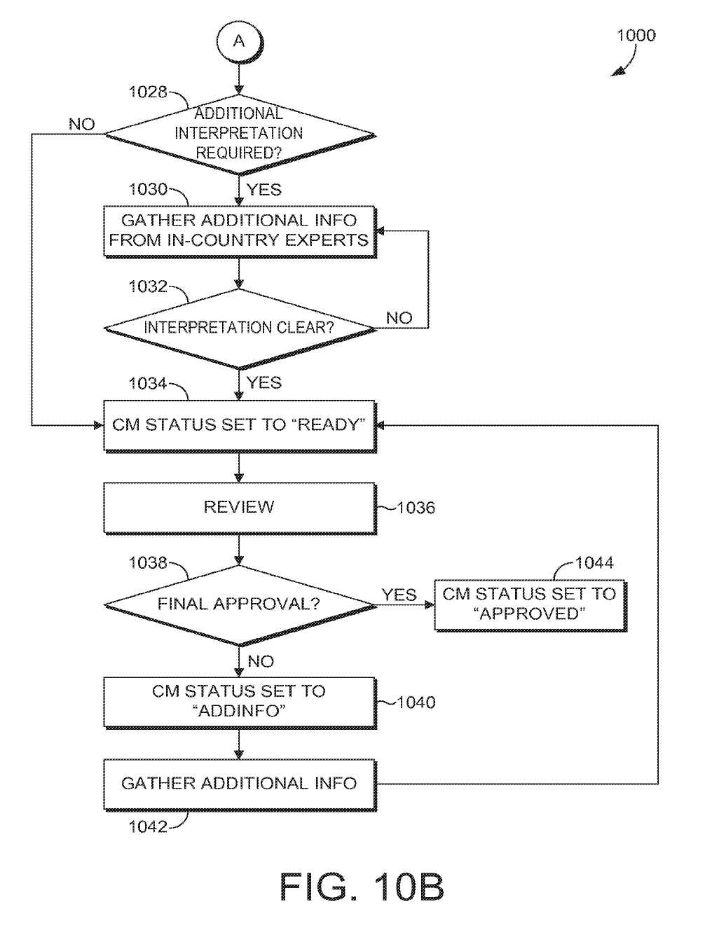

As shown at block 502, the review process of FIG. 5 includes initially reviewing reference changes identified by the change memo system to determine whether creation and/or further review of a change memo associated with the change is needed. The initial review process is discussed in further detail below with reference to FIG. 6. After the initial review process has been performed, the relevance of the change is examined, as shown at block 504. In particular, the change is reviewed to determine whether it is a type of change that warrants an update to an ERP system. The relevance determination process is discussed in further detail below with reference to FIG. 7. The relevance determination process may trigger a future change process 506 or a critical update process 508. Future changes correspond with changes that have not yet been enacted such that an ERP system update is not currently warranted but may be in the future. Critical updates correspond with changes that have an effective update within a predetermined period of time requiring expedited review of the change and implementation of an update to an ERP system. The future change process 506 and critical update process 508 will be discussed in further detail below with reference to FIGS. 8 and 9, respectively. The validation/publication process at block 510 involves obtaining sufficient information to verify that the originally identified change is valid. The validation/publication process 510 will be discussed in further detail below with reference to FIG. 10

Turning to FIG. 6, a flow process 600 for initially reviewing reference changes in accordance with one embodiment of the present invention is provided. As shown at block 602, a change in a reference is initially identified. The change may be identified, for instance, using the process 400 described above with reference to FIG. 4.

Whether a change memo corresponding with the identified change is already present in the change memo repository is determined at block 604. If a change memo corresponding with the identified change is not present in the change memo repository, a change memo is created at block 606. The status of the change memo is set to request, as shown at block 608.

Alternatively, if a change memo corresponding with the identified change is already present, a determination is made at block 610 regarding whether an update has already been implemented in an ERP system based on that change memo. If so, a determination is made if the reference change includes a legal requirement or guideline that has changed since that update was implemented, as shown at block 612. If the legal requirement or guideline has changed, a new change memo is created and the status set to request at blocks 606 and 608. If the legal requirement or guideline has not changed, the identified reference change is discarded, as shown at block 614.

Returning to block 610, if it is determined that an update to an ERP system has not been implemented based on the existing change memo, a determination is made at block 616 regarding whether the content of the legal requirement or guideline has changed between the existing change memo and the currently identified reference change. If the content has not changed, the identified reference change is discarded at block 614. Alternatively, if the content has changed, the existing change memo is modified, as shown at block 618. The status of the modified change memo is then set to request as shown at block 608.

A relevance determination process 700 in accordance with one embodiment of the present invention is illustrated in FIG. 7. The relevance determination process 700 may be triggered by a request status set for a change memo. As shown at block 702, the relevance of the change is determined. In particular, the change is examined to determine whether it is a type of change that warrants an update to an ERP system. If the change is determined not to be relevant in that an update to an ERP system is not warranted, the change memo status is set to discard, as shown at block 704.

If the change is determined to be relevant at block 702, whether the change has been enacted is considered at block 706. In particular, a legal requirement or guideline change may or may not have already been enacted by a responsible authority. If the change has not been enacted, whether the change is a future change is determined at block 708. If the change is not a future change, the change memo status is set to discard, as shown at block 704. Alternatively, if the change is determined to be a future change, the change memo status is set to future, as shown at block 710. The process of handling a change memo with a future status will be discussed in further detail below.

Returning to block 706, if the change has been enacted, the status of the change memo is set to validate, as shown at block 712. A determination is made at block 714 regarding whether the effective date for the change is within a predetermined period of time (e.g., one quarter) such that expedited review and development is required. If so, the priority of the change memo is set to critical at block 716. The process of handling a change memo with a critical priority will be discussed in further detail below. If the effective date of the change is not within the predetermined period of time, the priority of the change memo is set to high, medium, or low, as shown at block 718. The determination of the priority of the change memo may be based on factors such as the relevance of the change and its effective date.

A future change process in accordance with one embodiment will now be discussed with reference to FIG. 8, which illustrates a method 800 for reviewing future changes. As shown at block 802, a change memo having a future status is reviewed. The review of a change memo with a future status may be set on a scheduled basis (e.g., daily, weekly, monthly, etc.). Accordingly, reminders may be provided to prompt review of the change memo at scheduled times.

The change memo is reviewed to determine whether the change has been enacted. Accordingly, a determination is made at block 804 regarding whether the change has been enacted. If the change has been enacted, the change memo status is set to validate, as shown at block 806. Alternatively, if the change has not been enacted yet, a determination is made at block 808 regarding whether the change is still planned. If so, the change memo status remains as future and the change memo is reviewed again at later time as shown by the return to block 802. If it is determined that the change is not longer planned, the change memo status is set to discard, as shown at block 810.

With reference now to FIG. 9, a critical update review process 900 is shown. Upon setting the priority of a change memo to critical, senior management and development management are notified, as shown at block 902. Senior management then assigns ownership of the critical update, as shown at block 904. In particular, the critical update owner is responsible for overseeing an expedited review of the change for implementation. The critical update owner engages appropriate resources for review of the change at block 906. Additionally, the critical update owner conducts daily meetings for the critical update, as shown at block 908. Parties impacted by the critical update are notified daily, as shown at block 910.

A validation/publication process is performed for the critical update, as shown at block 912. A validation/publication process is performed for each change memo regardless of priority and will be discussed in further detail below. The difference for a critical update is that the validation/publication process is expedited for a critical update and the progress of the process is closely tracked. As shown at block 914, whether progress of the validation/publication process for the critical update is acceptable may be periodically verified. If the progress is not acceptable, executive management is notified at block 916, and the executive management is assigned as the critical update owner at block 918. Alternatively, if the progress is acceptable at block 914, it is determined at block 920 whether the validation/publication process is completed within a predetermined period of time (e.g., within 5 days). If the validation/publication process is not completed within the predetermined time period, the executive management is notified at block 922 and assigned as the critical update owner at block 918. Alternatively, if the validation/publication process is completed within the predetermined time period, the development team develops and implements an update to an ERP system based on the change, as shown at block 922.

Turning to FIGS. 10A and 10B, a flow diagram is provided that illustrates a method 1000 for validating a change memo and publishing the change memo for development in accordance with an embodiment of the present invention. The validation/publication process 1000 may be trigged by setting a validate status for the change memo. Initially, as shown at block 1002, it is determined whether the change memo being reviewed was generated from an original source. An original source is a source of information from the governing body issuing the change. For instance, if a municipality changes the sales tax, an original source would be a reference issued by that municipality regarding the sales tax change. In some instances, a change memo may be generated from an original source. In other instances a change memo may be generated from a secondary source. A secondary source is a source of information from a third-party describing a change by a particular governing body.

If the change memo was not generated from an original source, the process continues by attempting to confirm the change with the original governing body, as shown at block 1004. In particular, an attempt is made to locate a reference issued by the relevant governing body that describes the change. A determination is made at block 1006 regarding whether a reference from the governing body confirms the change. If such a confirmation cannot be made, an attempt to confirm the change is made with in-country experts, as shown at block 1008. An in-country expert is an individual who specializes in the legal requirements relevant to the geographic area to which the change pertains. A determination is made at block 1010 regarding whether the in-country experts can confirm the change. If the in-country experts cannot confirm the change, the change memo status is set to undocumented, as shown at block 1012.

Once the status of the change memo is set to undocumented, the change memo is reviewed on a scheduled basis for a set period of time to determine whether the change can be confirmed with the original governing body and/or an in-country expert, as shown at block 1014. For instance, the change memo may be reviewed quarterly for one year. In some instances, the review may result in the change being confirmed at block 1016. If so, the change memo status is changed to validate at block 1018. If the review does not result in the change being confirmed, a determination is made at block 1020 regarding whether the set period of time (e.g., one year) has expired. If not, the change memo status remains undocumented and the change memo may be reviewed again according to the scheduled basis for review. Once the set period of time expires, the change memo status is set to discard, as shown at block 1022.

If the change memo was generated from an original source or the change was confirmed with a governing body or an in-country expert, the process continues by confirming the change with a secondary source, as shown at block 1024. As noted above, a secondary source is a source of information provided by an entity other than the governing body. If a determination is made at block 1026 that a secondary source cannot be located that confirms the change, an attempt is made to confirm the change with an in-country expert.

When a secondary source is found that confirms the change, a determination is made at block 1028 regarding whether additional interpretation of the change is required. If so, additional information is gathered from in-country experts or other sources, as shown at block 1030. After additional information is gathered, the change memo is reviewed again to determine whether the interpretation is clear, as shown at block 1032. If not, additional information may be requested from in-country experts or obtained from other sources until the interpretation is clear.

When no additional interpretation is required, the change memo status is set to ready. Supervisor review of the change memo is then performed at block 1036. The review includes ensuring that the change in the change memo has been properly validated and no additional information is needed. A determination is made at block 1038 whether the change memo may be approved based on the supervisor review. If the change memo is not approved, the change memo status is set to addinfo, as shown at block 1040. Additional information regarding the change is then gathered to supplement the change memo, as shown at block 1042, and supervisor review is performed again. Once the supervisor approves the change memo, the change memo status is changed to approved, as shown at block 1044. The approved status may trigger a notification to a development team responsible for developing and implementing an update to an ERP system based on the change memo, as shown at block 1046. For example, the notification may be an email or other form of electronic notification.

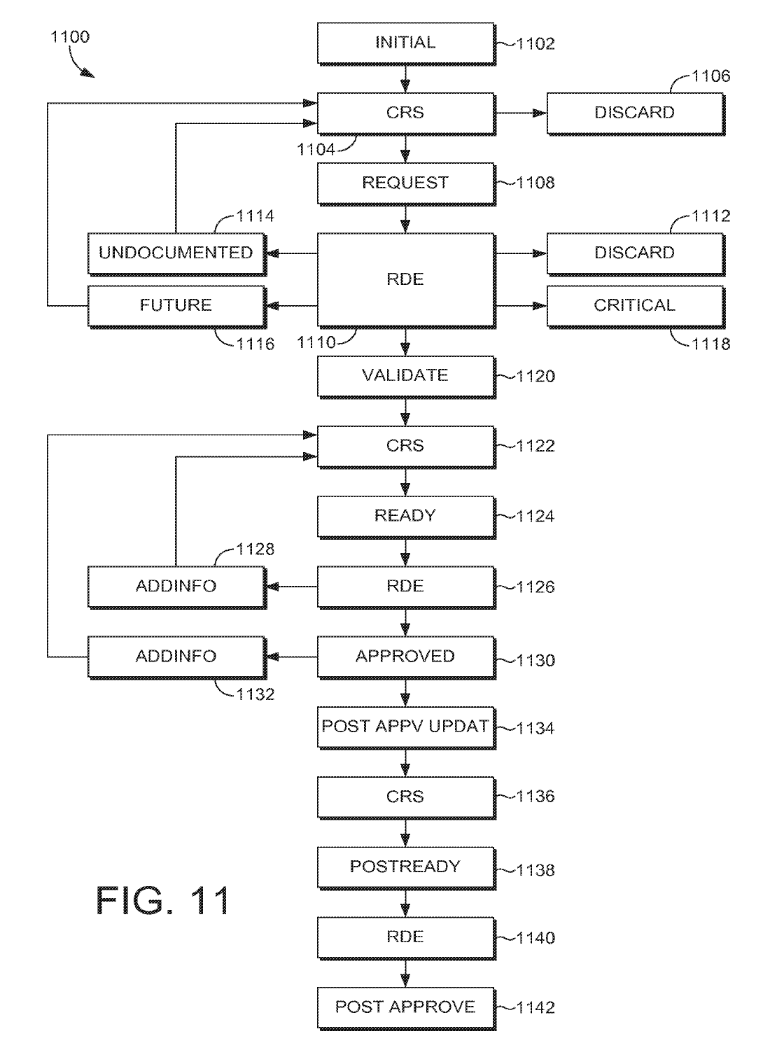

Referring now to FIG. 11, a flow diagram is provided that shows a change memo review process 1100 that illustrates the status progression of a change memo during review in accordance with an embodiment of the present invention. In the example embodiment shown in FIG. 11, the change memo is reviewed primarily by a country research specialist (CRS) and a regional domain expert (RDE). A CRS is an individual who is responsible for researching the legal requirements and other guidelines applicable to a given geographical area. An RDE is a manager to whom a CRS reports and who is responsible for reviewing the CRS's work. It should be understood, however, that embodiments of the present invention are not limited to review by a CRS and RDE but instead any number of individuals may be involved in reviewing a change memo for implementing an update to an ERP system.

As shown at block 1102, the process begins with a change memo having an initial status. When the system detects a change in a reference, a change memo may be created based on the change. However, since the change has not been reviewed yet, the change memo has an initial status.

The change is initially reviewed by a CRS, as shown at block 1104. Among other things, the CRS may consider whether the change is something that warrants an update to an ERP system. Additionally, the CRS may determine whether a change memo already exists that captures the change. In some instances, the CRS may determine that the change does not warrant an update or a change memo already exists with that change. Accordingly, the CRS may set the change memo status to discard, as shown at block 1106. Alternatively, the CRS may set the change memo status to request, as shown at block 1108.

Based on the request status, an RDE is notified and reviews the change memo, as shown at block 1110. The RDE oversees the CRS's review of the change memo and confirms, among other things, whether the change warrants an update to an ERP system and/or whether a change memo already exists with that change. Based on the review, the RDE may decide to set the change memo status to one of a number of different statuses. In some instances, the RDE may decide that the change does not warrant an update or that the change has already been captured in another change memo. As such, the RDE may set the change memo status to discard, as shown at block 1112. In some instances, the RDE may review the change memo and believe that insufficient information is available to move forward. If so, the RDE may set the change memo status to undocumented, as shown at block 1114. If the change memo status is set to undocumented, the CRS is notified and performs research to determine if additional information regarding the change can be located. If so, the CRS may change the status back to request. If no additional information is located with a certain period of time, the change memo status may be set to discard.

The RDE may also determine at block 1110 that the change has not been enacted yet. If so, the RDE may set the change memo status to future, as shown at block 1116. The CRS is notified of the future status and is reminded on a set schedule to review the change to determine if the change has been enacted. If so, the change memo status may again be set to review. At some point, if the change has not been enacted or evidence is found that it will not be enacted, the change memo status may be set to discard.

The RDE may also set the priority of the change memo at block 1110. In some instances, the RDE may determine that the change is going to occur within a predetermined period of time (e.g., 60 days). Based on the determination, the RDE may set the priority for the change memo to critical, as shown at block 1118, which triggers an expedited review of the change memo for implementation to an ERP system. Alternatively, the RDE may set the priority to high, medium, or low based on factors such as the time remaining before the change takes effect and/or the importance of the change.

If the RDE believes the review of the change memo may proceed, the change memo status is set to validate, as shown at block 1120. The CRS is notified of the validate status and begins a validation review of the change memo, as shown at block 1122. In embodiments, validation requires at least two sources that document the change. Accordingly, at block 1122, the CRS attempts to find additional sources of information regarding the change and attaches the documentation to the change memo.

Once the validation review by the CRS is complete, the change memo status is set to ready, as shown at block 1124. The RDE is notified of the ready status and begins validation review of the change memo, as shown at block 1126. The RDE reviews the documentation attached to the change memo by the CRS and verifies that sufficient information is included to validate the change.

The RDE may determine during the review at block 1126 that additional information is needed. If so, the change memo status is set to addinfo, as shown at block 1128. The CRS is notified of the addinfo status and performs additional research to add additional information to the change memo to validate the change. Once completed the change memo status is again set to ready for additional RDE review. In some instances, the CRS's research may dictate that the change does not warrant an update, insufficient information is available, or that the change has not yet been enacted. As such, the RDE may decide at block 1126 to set the change memo status to discard, undocumented, or future (not shown).

If the RDE is satisfied that there is sufficient information to validate the change, the RDE may set the change memo status to approved, as shown at block 1130. A notification is sent to the development team that the change memo has been approved such that the development team may develop and implement a change to an ERP system based on the change in the change memo. In some cases, the development team may want additional information. If so, the development team may change the change memo status to addinfo, as shown at block 1132. The CRS is notified of the addinfo status and may attempt to find additional information and attach the information to the change memo for use by the development team.

Some embodiments of the present invention include a post-approval process for change memos. The post-approval process may be used if it is determined that additional information should be added the change memo or a correction to a change memo is needed. The additional information and/or correctional information may be added, for instance, for record-keeping purposes. Initially, the change memo status may be set to postappvupdat, as shown at block 1132. The CRS is notified of the postappvupdat status, performs research and may add additional information and/or corrections to the change memo at block 1136. Once the CRS's work is completed, the change memo status is set to postready, as shown at block 1138. The RDE is notified of the postready status and reviews the additional/correctional information at block 1140. If the RDE is satisfied, the change memo status is change to postapprove, as shown at block 1142.

It should be noted that notifications provided by the system, such as those described above with reference to FIG. 11 and otherwise discussed herein, are user-configurable. In other words, notifications are configured in the system as to who receives notifications and at which step(s). For instance, an administrator or other person may set which status, priority, or other changes will automatically trigger a notification. Additionally, the administrator or other person may set which users receive each notification. The notifications may comprise an email sent to an intended recipient or other form of electronic notification.

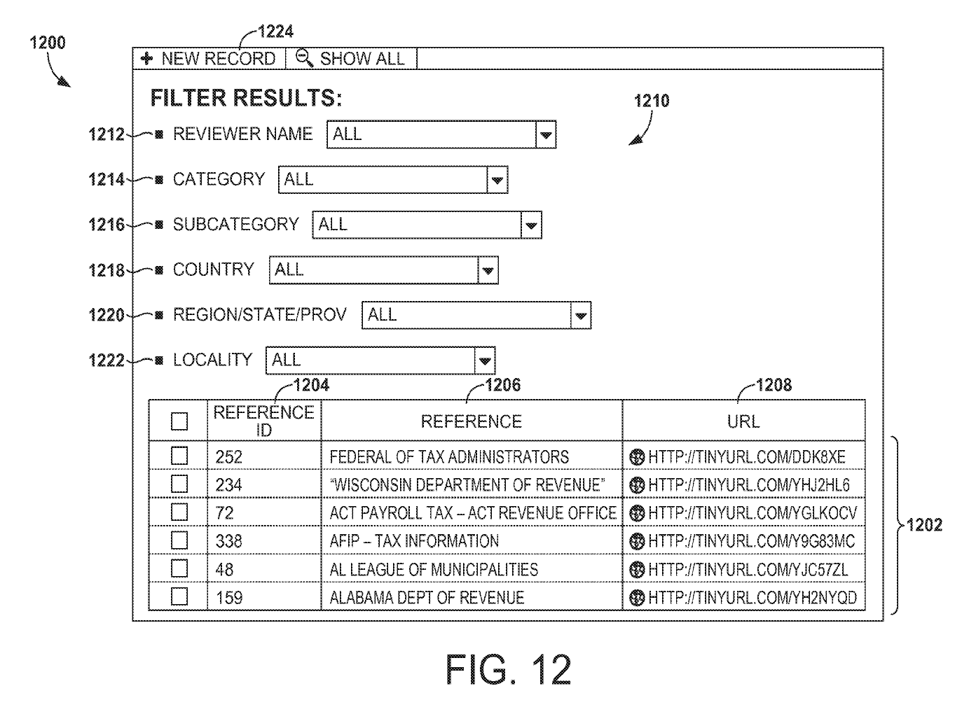

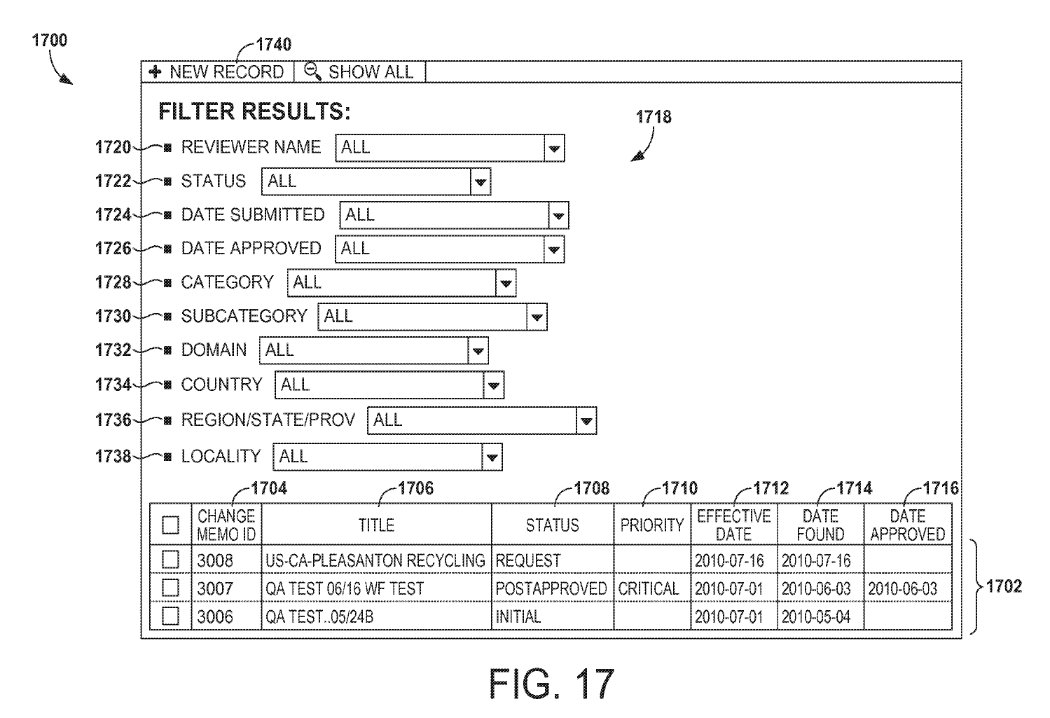

As discussed previously, embodiments of the present invention include graphical user interfaces that facilitate tracking the review status of changes made to references for possible updates to ERP systems. FIGS. 12 through 16 are illustrative graphical user interfaces used to manage references being tracked for changes by the system, as well as changes identified by the system. FIGS. 17 through 21 are illustrative graphical user interfaces used to manage review of change memos. It will be understood and appreciated by those of ordinary skill in the art that the screen displays of FIGS. 12 through 21 are provided by way of example only and are not intended to limit the scope of the present invention in any way.

Referring to FIGS. 12 through 16, a series of user interfaces are shown that allow a user to manage the references watched by the system for changes that may impact ERP systems. With initial reference to FIG. 12, a user interface 1200 is shown that includes a list of references 1202 being tracked by the change memo system. A reference ID 1204, reference title 1206, and URL 1208 is indicated for each reference. As such, the user interface 1200 allows a user to view the references being tracked for changes that may impact ERP systems.

The user interface 1200 includes a filter area 1210 that allows a user to filter references shown in the list of references 1202. In particular, the filter area 1210 allows a user to filter by: reviewer name 1212, category 1214, subcategory 1216, country 1218, region/state/province 1220, and locality 1222. Other filter types may be available in various embodiments of the invention. Additionally or alternatively, a search feature may be provided in some embodiments to allow users to search for references by entering search terms.

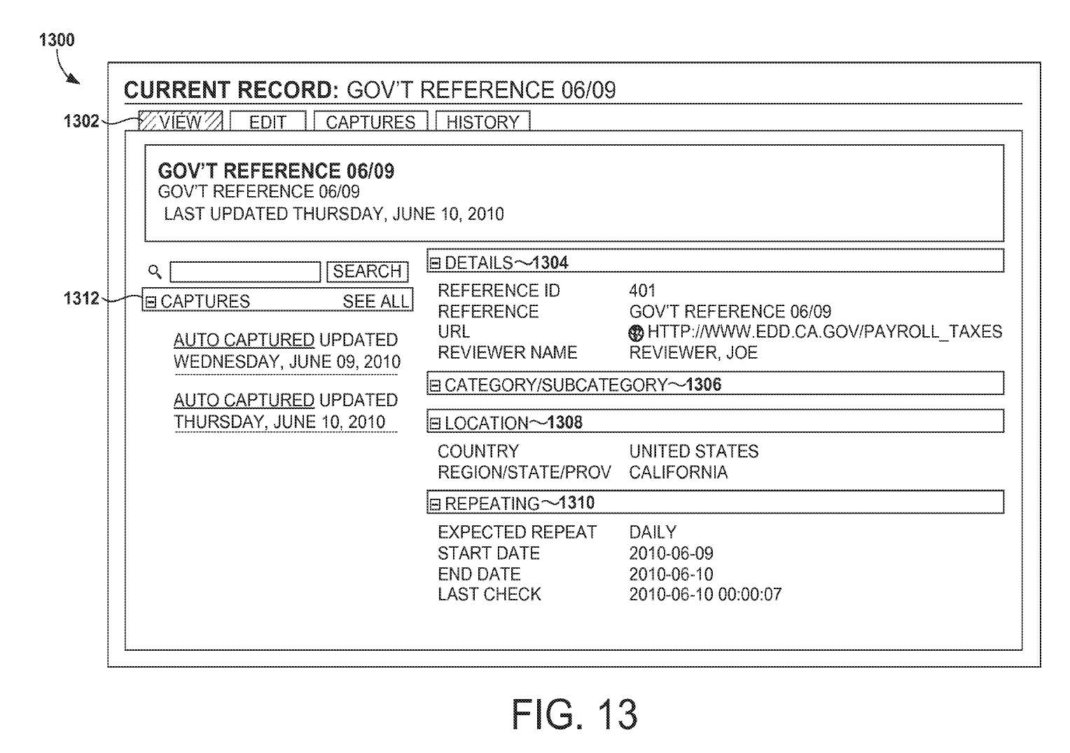

A user may select a reference from the list of references 1202 to view and/or edit details of the record for that reference. FIG. 13 illustrates a user interface 1300 showing the view tab 1302 for a selected reference record providing the details of the selected reference. As shown in FIG. 13, the details 1304 include general information for the reference, including: a reference ID, a reference name, a URL at which the reference is located, and the name of the reviewer assigned to reviewing the reference. The view tab 1302 also indicates a category/subcategory 1306 assigned to the reference and a geographical location 1308 to which the reference pertains. The view tab 1302 further includes repeating information 1310 regarding the frequency with which the reference is captured to check for changes. As shown in FIG. 13, the current reference is captured daily. A start date, end date, and last checked date are also indicated for the reference. The view tab 1302 still further includes capture information 1312 showing when the reference was captured by the system.

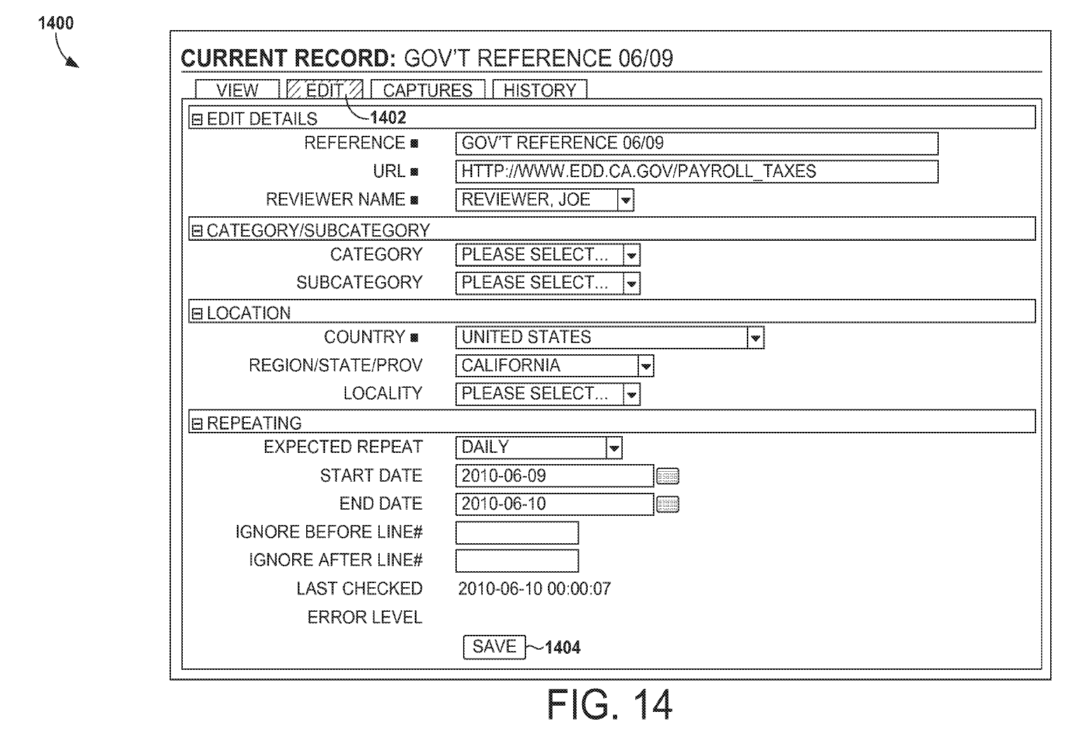

FIG. 14 illustrates a user interface 1400 that shows the edit tab 1402 of a reference record, which allows a user to edit details of the reference record. The edit tab 1402 provides the same information shown in the view tab 1302 but allows a user to edit the information for the reference. As shown in FIG. 14, the user may set not only the frequency with which the reference is captured, but the user can also specify a portion of the reference to capture by setting to ignore the reference before a specified line and after a specified line. If the user enters information for these features, only the portion of the reference between the specified lines is captured. It should be understood that other approaches for allowing a user to specify a portion of a reference to capture may be employed within the various embodiments of the present invention. After making any changes to the reference record, the user may save the changes by selecting the save button 1404.

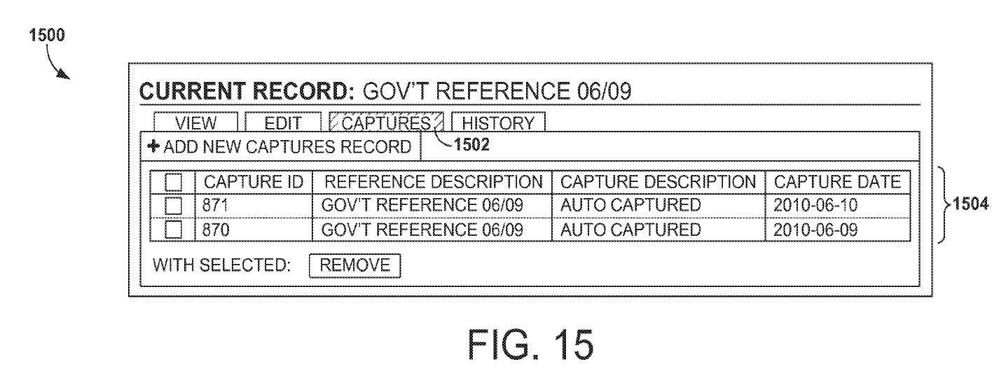

The reference record also includes a captures tab 1502 as shown in the user interface 1500 of FIG. 15. The captures tab 1502 provides a listing of captures 1504 for the reference. Each item in the listing of captures 1504 corresponds with a single capture of the reference. Details for each capture include a capture ID, a reference title, a capture description, and a capture date.

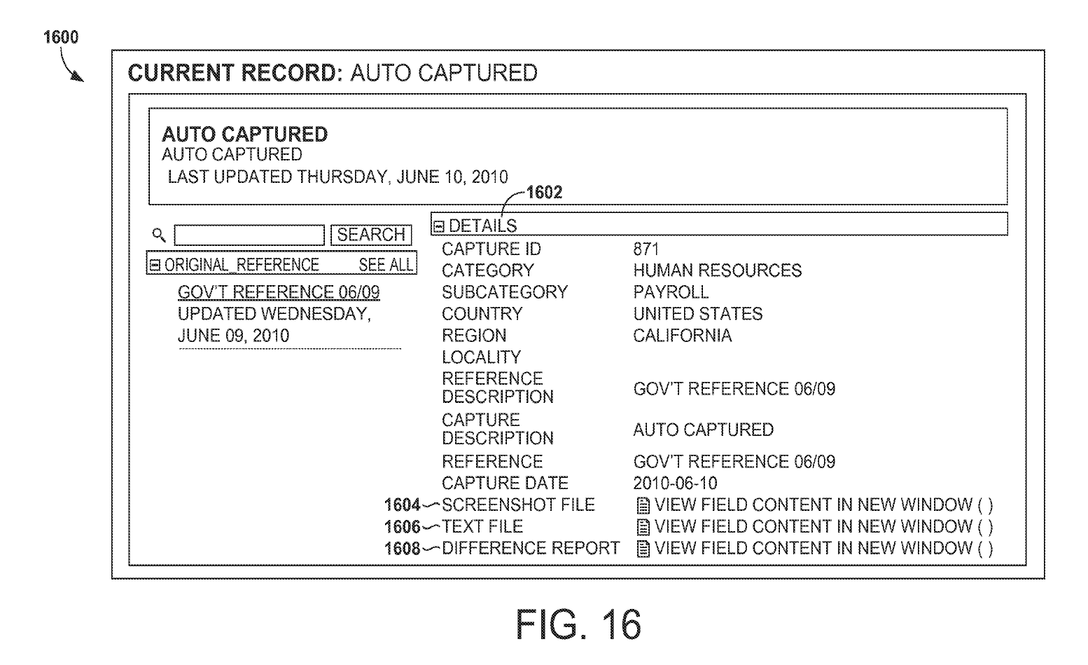

A user may select a capture from the list of captures 1502 to view particulars of the capture. FIG. 16 illustrates a user interface 1600 that provides details of a particular capture selected by the user. As shown in FIG. 16, the user interface 1600 includes general details 1602 regarding the selected capture, including capture ID, category, subcategory, country, region, locality, reference description, capture description, and capture date. Additionally, the user interface 1600 provides links to access the reference captures. In particular, the user can select to view a screenshot file 1604 that contains a screenshot of the captured reference. Additionally, the user can select to view a text file 1606 that contains just the text of the captured reference. The user can further select to view a difference report 1608 that shows the difference between the current capture of the reference and the previous capture.

Returning to FIG. 12, in addition to viewing existing reference records, the user interface 1200 allows a user to add new references to be tracked for changes that may impact ERP systems. In particular, the user interface 1200 includes a new record button 1224. By selecting the new record button 1224, a user interface is provided similar to the reference edit user interface 1400 shown in FIG. 14. Accordingly, the user may enter details of the new reference including the URL of the reference and the frequency with which to capture the reference. After a new record has been created and saved, the reference will be captured by the system according to the frequency specified for the reference.

Turning now to FIGS. 17 through 21, a series of user interfaces are shown that facilitate the review and management of change memos. With initial reference to FIG. 17, a user interface 1700 is shown that provides a list of change memos 1702 stored in the change memo repository. Summary information provided for each change memo in the list of change memos 1702 includes a change memo ID 1704, title 1706, status 1708, priority 1710, effective date 1712, date found 1714, and date approved 1716.

The user interface 1700 includes a filter area 1718 that allows a user to filter change memos shown in the list of change memos 1702. In particular, the filter area 1718 allows a user to filter by: reviewer name 1720, status 1722, date submitted 1724, date approved 1726, category 1728, subcategory 1730, domain 1732, country 1734, region/state/province 1736, and locality 1738. Other filter types may be available in various embodiments of the invention. Additionally or alternatively, a search feature may be provided in some embodiments to allow users to search for change memos by entering search terms.

The user interface 1700 allows a user to view and manage change memos in the change memo repository. A user may select a particular change memo to view and edit the details of the change memo including the change memo status as part of the review process for the change memo.

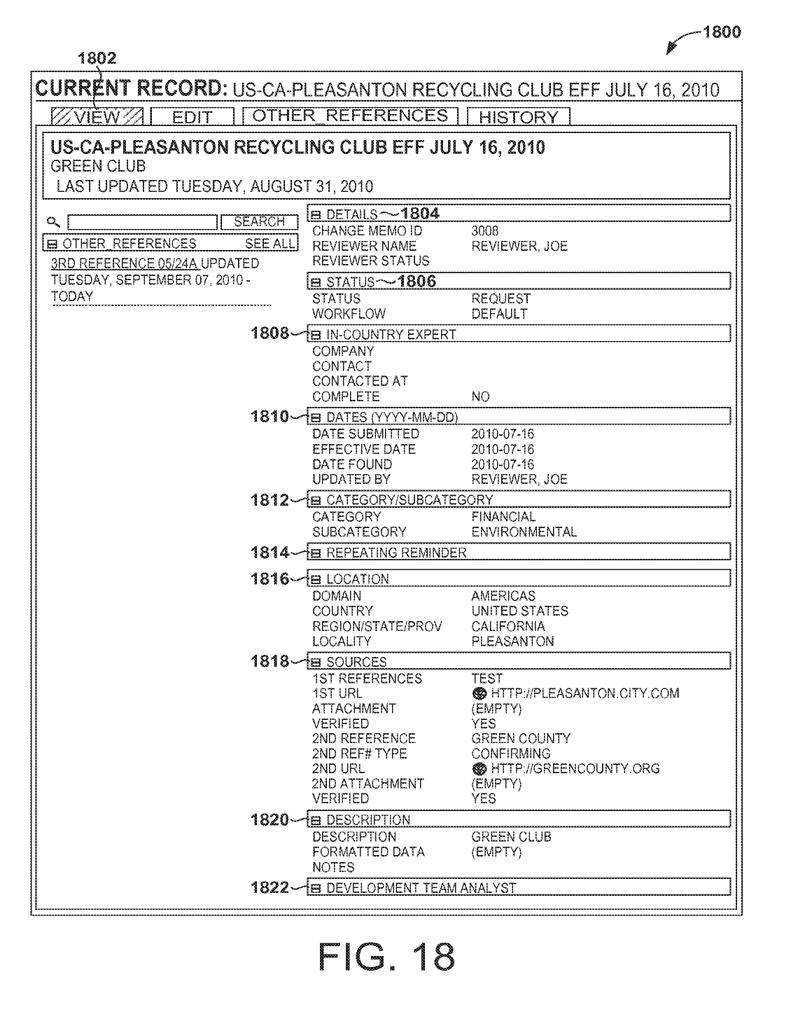

FIG. 18 illustrates a user interface 1800 in which a user has selected a change memo record and is shown the view tab 1802 for the change memo record showing information for the selected change memo. As shown in FIG. 18, a details area 1804 includes general information for the change memo, including: a change memo ID, a reviewer name, and a reviewer status. The view tab 1802 also indicates the status 1806 of the change memo, an in-country expert 1808 for the change memo, relevant dates 1810 for the change memo, a category/subcategory 1812 assigned to the change memo, repeating reminder information 1814 regarding how a reminder is sent to the reviewer for the change memo, a geographical location 1816 to which the reference pertains, source information 1818 detailing information regarding the sources of information being used to validate the change, a description area 1820 that includes a description and notes for the change memo, and information regarding development team analysts 1822 responsible for implementing any updates based on the change memo.

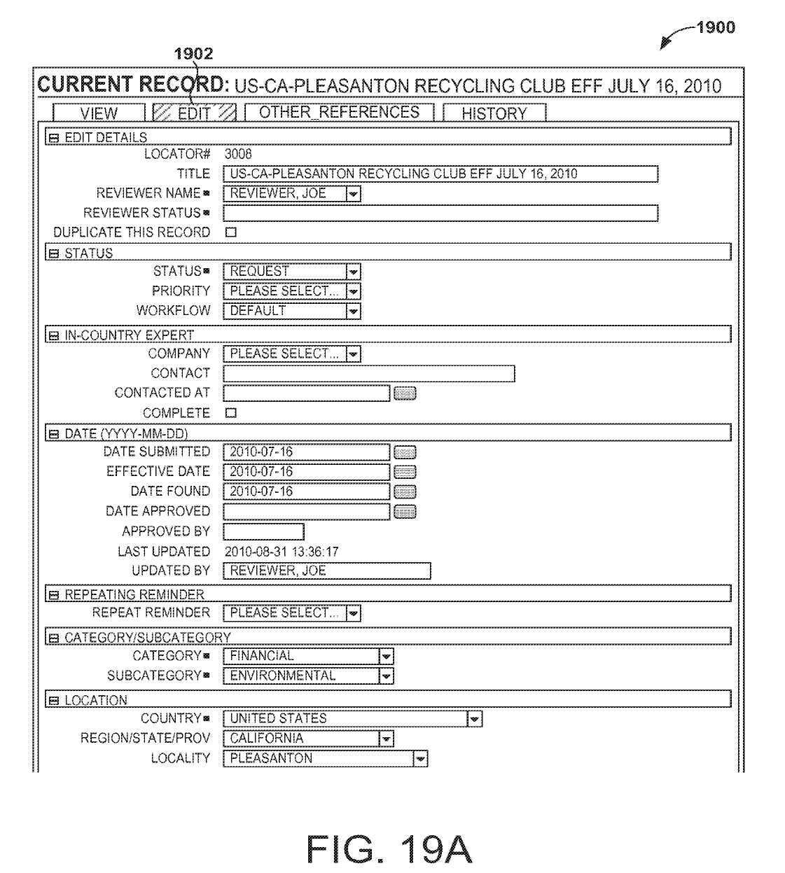

FIGS. 19A and 19B illustrate a user interface 1900 that shows the edit tab 1902 of a change memo record, which allows a user to edit details of the change memo record. The edit tab 1902 provides the same information shown in the view tab 1802 but allows a user to edit the information for the change memo. A reviewer may employ the edit tab during review of the change memo to edit various details of the change memo including setting the change memo status as review progresses. Additionally, the reviewer may add notes to the change memo record to document details regarding review of the change memo. For instance, the review may wish to include notes regarding why the change memo was given a particular status. In addition to modifying the various details of the change memo, the edit tab 1902 allows a reviewer to indicate references used to validate the change and attach the references to the change memo. After making any changes to the change memo record, the user may save the changes by selecting the save button 1904.

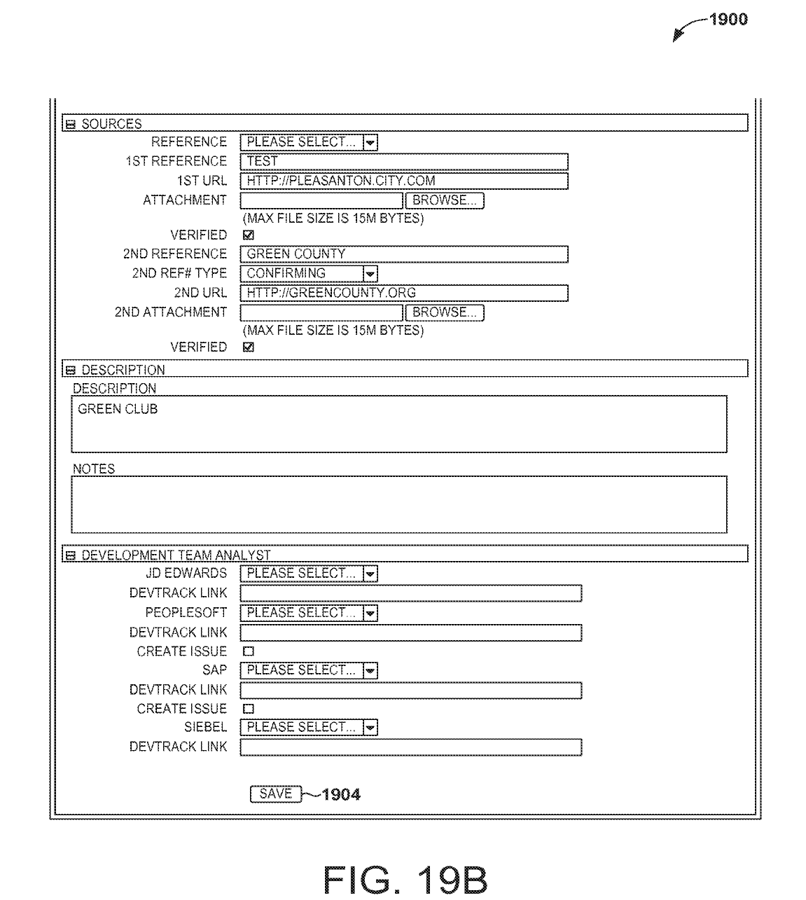

The change memo record also includes an other references tab 2002 as shown in the user interface 2000 of FIG. 20. As noted above, the edit tab 1902 shown in FIGS. 19A and 19B allows a user to enter information and/or attach two references. The other references tab 2002 provides a listing of any additional references 2004 for the change memo. Details provided for each additional reference include a change memo id, reference title, type of reference, URL for the reference, and an attachment with the reference. A user may add additional references by selecting an add new reference button 2006 and providing information for the additional reference.

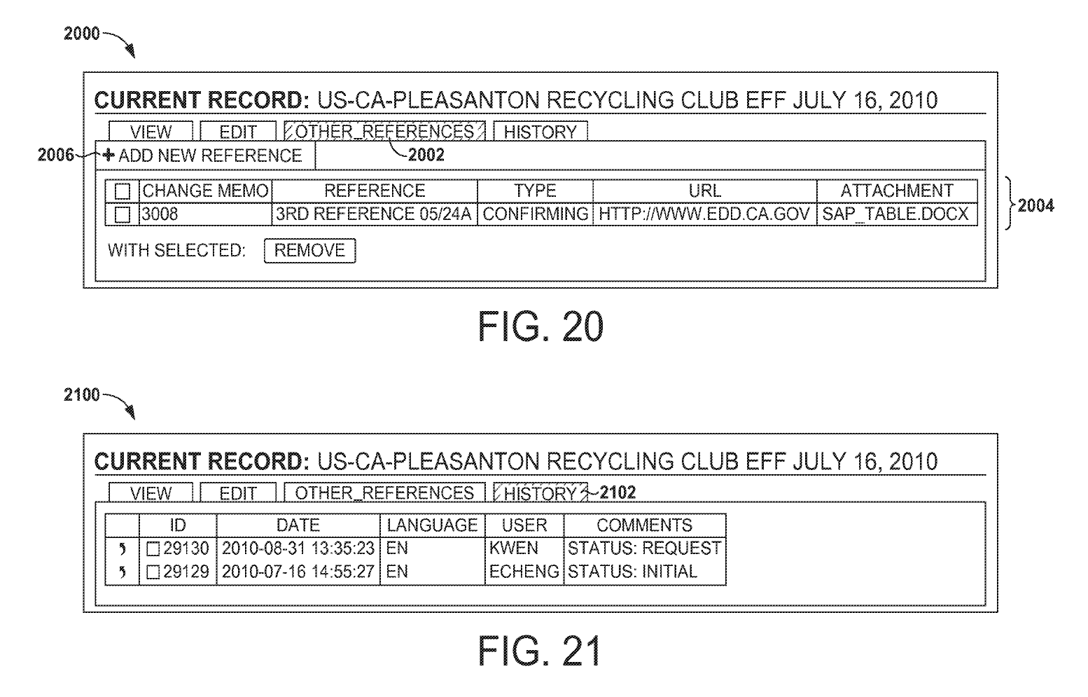

The change memo record further includes a history tab 2102 as shown in the user interface 2100 of FIG. 21. The history tab 2100 includes a list of history items for the change memo. The history information may include, for instance, an indication of when the status of a change memo was changed.

Returning to FIG. 17, in addition to viewing existing change memo records, the user interface 1700 allows a user to create new change memos. In particular, the user interface 1700 includes a new record button 1740. By selecting the new record button 1740, a user interface is provided similar to the change memo edit user interface 1900 shown in FIGS. 19A and 19B. Accordingly, the user may enter details of the new change memo and save the change memo as a new record.

As can be understood, embodiments of the present invention provide a change memo system that automatically identifies reference changes that may impact ERP systems and facilitates review of change memos documenting the reference changes to determine if updates to ERP systems are warranted based on the changes.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more non-transitory computer-readable storage media storing computer-useable instructions that, when executed by one or more computing devices, cause the one or more computing devices to perform a method comprising:
accessing, over one or more communication networks, an electronic reference at a content host to identify a modification to metadata impacting the functioning of an enterprise resource system;
generating, at a change memo host, a change memo with a first entry incorporating a digital reproduction of the electronic reference capturing the metadata, wherein the generated change memo is confirmed based on a second entry for an additional electronic reference also identifying the modification to the metadata impacting the functioning of the enterprise resource system; and
in response to tracking a status of the change memo by the change memo host, prompting an update of the enterprise resource system based on the metadata associated with the electronic reference, the tracked status indicating that the modification of the metadata is confirmed.

2. The one or more computer-readable storage media of claim 1, wherein the electronic reference is associated with a uniform resource locator (URL).

3. The one or more computer-readable storage media of claim 2, wherein accessing the electronic reference is in response to a predetermined configurable routine.

4. The one or more computer-readable storage media of claim 1, wherein the electronic reference comprises a data feed and wherein accessing the electronic reference comprises receiving the data feed.

5. The one or more computer-readable storage media of claim 1, wherein the modification to metadata is identified based on conflicting versions of metadata.

6. The one or more computer-readable storage media of claim 1, wherein the change memo is automatically generated in response to identifying the modification to metadata.

7. The one or more computer-readable storage media of claim 1, wherein the change memo is generated based on user input that is received subsequently to providing the electronic reference to a user.

8. The one or more computer-readable storage media of claim 1, wherein the status of the change memo may be set to one selected from the following: initial, request, discard, undocumented, future, validate, ready, addinfo, and approved.

9. The one or more computer-readable storage media of claim 1, wherein the update to the enterprise resource planning system reflected in the change memo is tested in a testing environment.

10. The one or more computer-readable storage media of claim 1, wherein identifying the modification to the metadata includes identifying an update to a legal requirement.

11. A computer implemented method comprising:
accessing, over one or more communication networks, an electronic reference at a content host to identify a modification to metadata impacting the functioning of an enterprise resource system;
generating a change memo at a change memo host with a first entry incorporating a digital reproduction of the electronic reference capturing the metadata, wherein the generated change memo is confirmed based on a second entry for an additional electronic reference also identifying the modification to the metadata impacting the functioning of the enterprise resource system; and
in response to a tracking indicator of the change memo by the change memo host, prompting an update of the enterprise resource system based on the metadata associated with the electronic reference, the tracking indicator indicating that the modification of the metadata is confirmed.

12. The method of claim 11, wherein the electronic reference is associated with a uniform resource locator (URL).

13. The method of claim 11, wherein accessing the electronic reference is in response to a predetermined configurable routine.

14. The method of claim 11, wherein the electronic reference comprises a data feed and wherein accessing the electronic reference comprises receiving the data feed.

15. The method of claim 11, wherein the modification to metadata is identified based on conflicting versions of metadata.

16. The method of claim 11, wherein the change memo is automatically generated in response to identifying the modification to metadata.

17. The method of claim 11, wherein the change memo is generated based on a user input that is received subsequently to providing the electronic reference to a user.

18. The method of claim 11, wherein the change memo has a priority selected from one of the following: critical, high, medium, and low.

19. The method of claim 11, wherein identifying the modification to the metadata includes identifying updates to a legal requirement.

20. A computerized system comprising:
at least one processor;
at least one computer-readable storage medium;
a change identification component that accesses, over one or more communication networks, an electronic reference at a content host to identify a modification to metadata impacting the functioning of an enterprise resource system;
a data store storing a plurality of change memos, each change memo comprising a first entry incorporating a digital reproduction of the electronic reference capturing the metadata, wherein the generated change memo is confirmed based on a second entry for an additional electronic reference also identifying the modification to the metadata impacting the functioning of the enterprise resource system; and
a communications component that instructs an update of the enterprise resource system based on the metadata associated with the electronic reference in response to tracking a status of the change memo, the tracked status indicating that the modification of the metadata is confirmed.
